(19) United States
(12) Patent Application Publication
(10) Pub. No.: US 2007/0156488 A1
(43) Pub. Date: Jul. 5, 2007

(54) System and method to embed checklist items and issues in project management

(76) Inventors: Volker Faisst, Llvesheim (DE); Otfried von Geisau, Sinsheim (DE); Michael Meyringer, Rauenberg (DE)

Correspondence Address: SCHWEGMAN, LUNDBERG, WOESSNER & KLUTH, P.A., P.O. BOX 2938, MINNEAPOLIS, MN, 55402, US

(21) Appl. No.: 11/322,327

(22) Filed: Dec. 30, 2005

(51) Int. Cl. G06F 9/46

(52) U.S. Cl. 705/8

(57) ABSTRACT

In an embodiment, a process for managing a project includes providing a first project summary task node, one or more second summary task nodes that are associated with the first project summary task node, and one or more third task nodes that are associated with each second summary task node. The process further provides a checklist that has associated with it one or more checklist items. One or more tasks are associated with each checklist item. In this embodiment, the one or more tasks for a checklist item are associated with one or more of the first project summary task node, the second summary task nodes, and the third task nodes.

### BACKGROUND

Project management is the process of overseeing complex business processes or projects to completion. In academic and commercial circles, there are many theories and systems in project management. In one relatively well-known and utilized project management system, as illustrated in FIG. 1, a hierarchical tree structure 100 is used to identify the different tasks and task levels in a project. For example, there may be a project summary task 110 at the tree node, one or more summary tasks 120 below the tree node, and one or more tasks 130 coupled to each summary task.

Also associated with such project management hierarchical structures are checklists 140. In a typical hierarchical project management structure, a checklist may be added to the hierarchical structure when a new process is added to the project. Associated with the checklist is a list of checklist tasks 145 that are used to implement the checklist. These tasks 145 are associated with the checklist, and not the other tasks 130 in the main hierarchical tree.

### SUMMARY

In an embodiment, a process for managing a project includes providing a first project summary task node, one or more second summary task nodes that are associated with the first project summary task node, and one or more third task nodes that are associated with each second summary task node. The process further provides a checklist that has associated with it one or more checklist items. One or more tasks are associated with each checklist item. In this embodiment, the one or more tasks for a checklist item are associated with one or more of the first project summary task node, the second summary task nodes, and the third task nodes.

### BRIEF DESCRIPTION OF THE DRAWINGS

FIG. 1 is an example embodiment of a project management hierarchical tree structure.

FIG. 2 is an example embodiment of a project management hierarchical tree structure.

FIG. 3 is an example embodiment of a process to implement a project management hierarchical tree structure.

FIG. 4 is an example embodiment of a system architecture upon which one or more embodiments of the invention may execute.

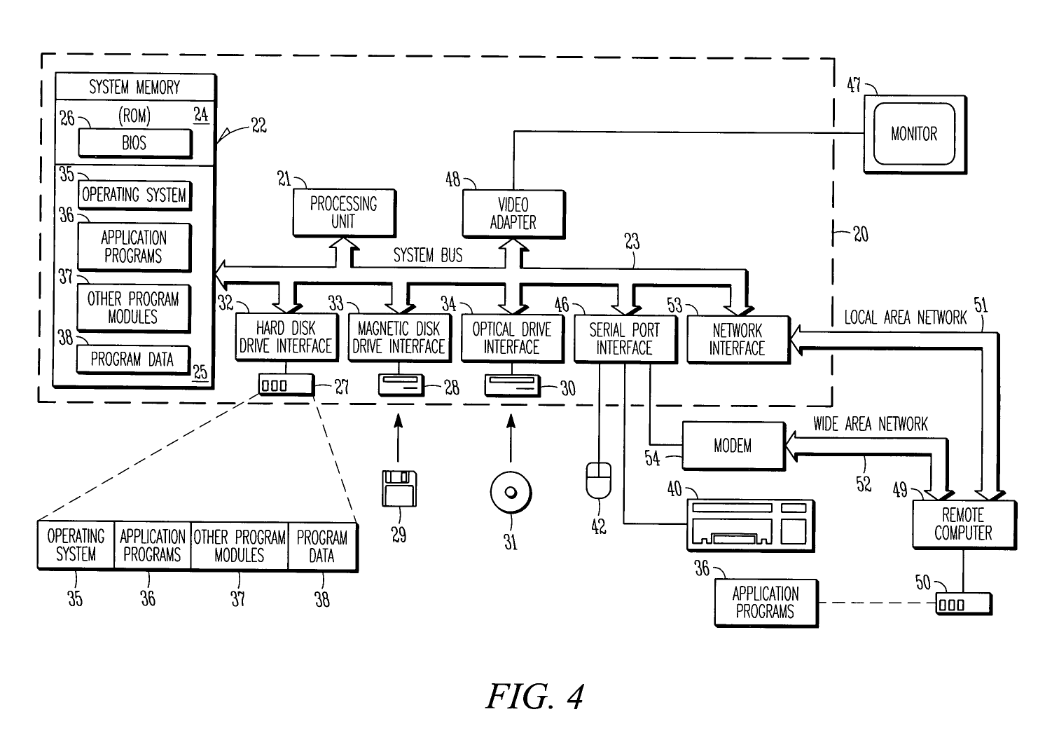

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description is, therefore, not to be taken in a limited sense, and the scope of the present invention is defined by the appended claims.

The functions or algorithms described herein are implemented in software or a combination of software and human implemented procedures in one embodiment. The software comprises computer executable instructions stored on computer readable media such as memory or other type of storage devices. The term “computer readable media” is also used to represent carrier waves on which the software is transmitted. Further, such functions correspond to modules, which are software, hardware, firmware or any combination thereof. Multiple functions are performed in one or more modules as desired, and the embodiments described are merely examples. The software is executed on a digital signal processor, ASIC, microprocessor, or other type of processor operating on a computer system, such as a personal computer, server or other computer system.

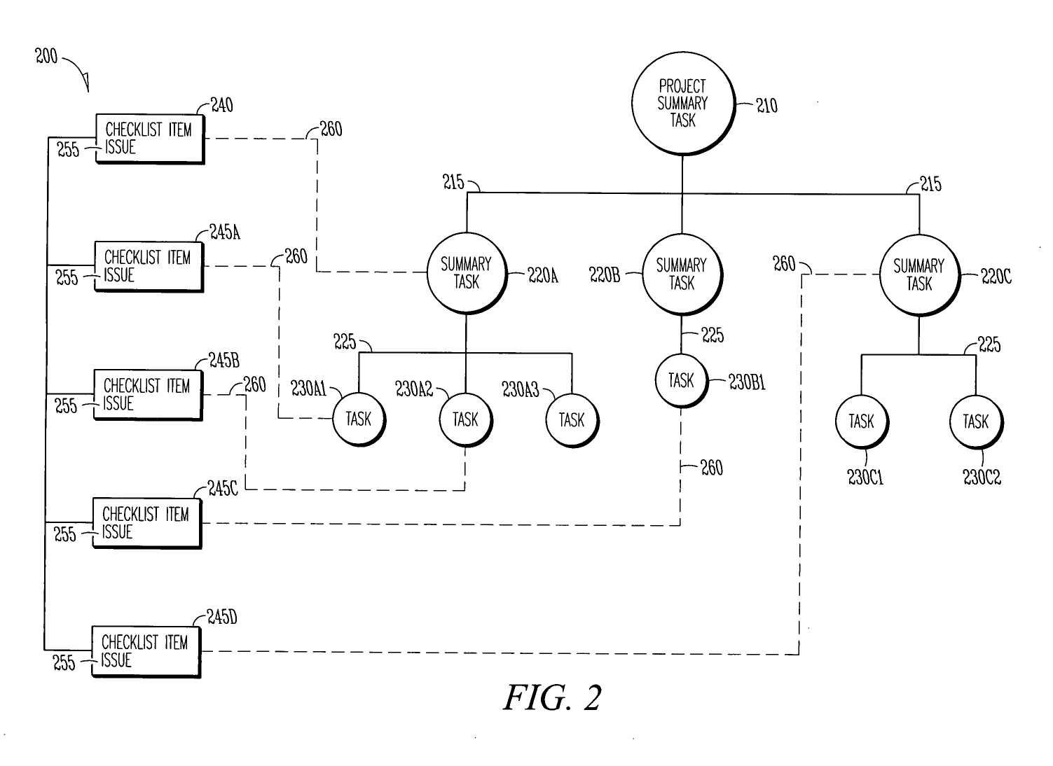

FIG. 2 illustrates an example embodiment of a project management structure 200. The structure is a tree structure, and includes a project summary task node 210. The project summary task node 210 has associated with it via links 215 one or more summary task nodes 220A, 220B, and 220C. Similarly, each summary task node 220A, 220B, and 220C has associated with it via links 225 one or more task nodes 230A1, 230A2, and 230A3; 230B1; and 230C1 and 230C2. It should be noted that FIG. 2 is just one example embodiment of a project management structure, and that other structures are contemplated that involve more hierarchical levels than the three levels illustrated in FIG. 2.

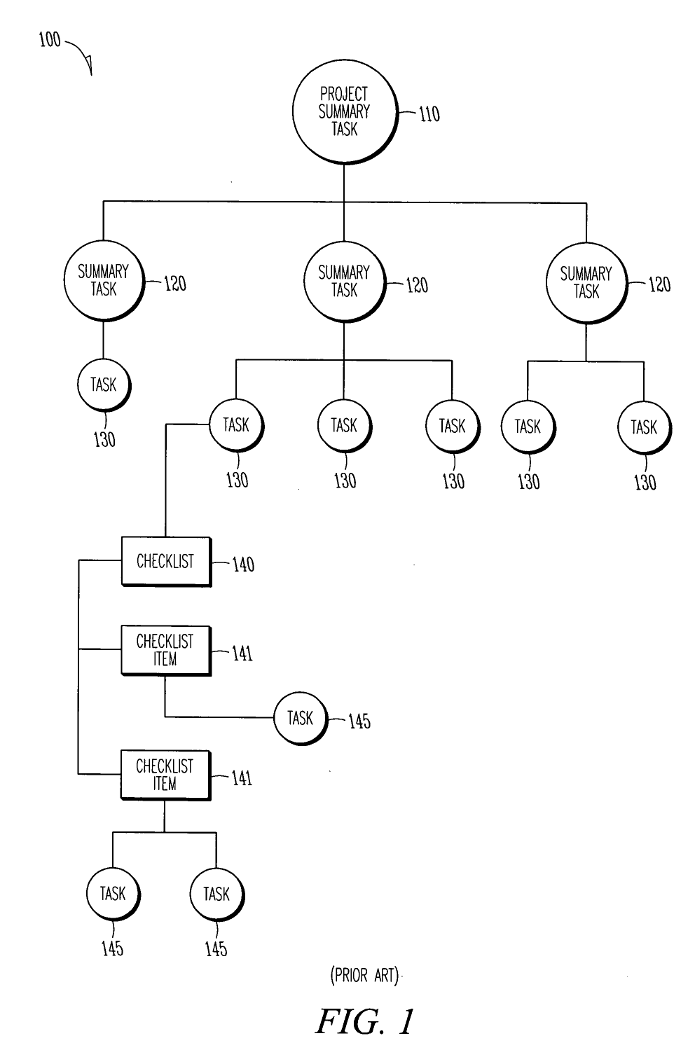

FIG. 2 further illustrates a checklist 240. The checklist 240 has associated with it one or more checklist items 245A, 245B, 245C, and 245D. The checklist 240 further includes a field 255 in which it can be indicated that it is an issue list. The checklist 240 and the one or more checklist items 245A, 245B, 245C, and 245D may be associated via links 260 with one or more of the project summary task node 210, the summary task nodes 220A, 220B, and 220C, and/or the task nodes 230A1, 230A2, and 230A3; 230B1, and 230C1 and 230C2. It should be noted once again that FIG. 2 is just an example embodiment of a particular project management tree with embedded checklists. One of skill in the art will realized that many more structures in addition to the particular structure of FIG. 1 may be implemented.

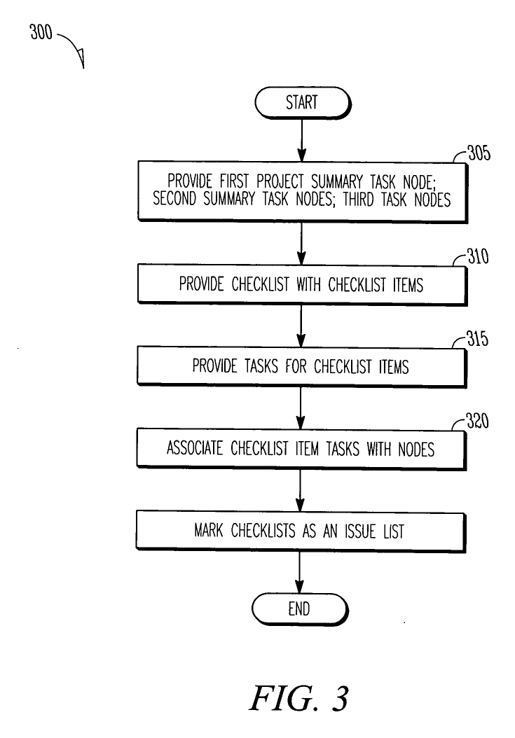

FIG. 3 illustrates an example embodiment of a process 300 to create a project management structure such as the structure 200 in FIG. 2. Specifically, FIG. 3 illustrates at operation 305 the provision of a first project summary task node, one or more second summary task nodes that are associated with the first project summary task node, and one or more third task nodes for each second summary task node. At operation 310, a checklist is provided that has one or more checklist items. One or more tasks are provided for the checklist items at operation 315. Then, at operation 320, the one or more tasks for a checklist item are associated with one or more of the first project summary task node, the second summary task nodes, and the third task nodes.

After the general structure of the project management hierarchy is created as outlined in operations 305, 310, 315, and 320, one or more additional checklists may be configured to monitor a predefined aspect of the project. For example, if the project that is being managed is the design of a new automobile, and a new government regulation is imposed that requires a change in the design of the brakes, a new checklist may have to be created with associated tasks to follow the design/redesign of the brakes. These new tasks associated with the brakes can then be associated with other summary tasks or tasks that are related in some way to these new tasks from the checklist. Thereafter, one or more of the first project summary task node, the second summary task nodes, and the third task nodes are associated with a plurality of checklists. After a new checklist item is created, an associated new task is created. When the new checklist item is created, the checklist item and the associated new task are linked to an existing one or more of the first project summary task node, the second summary task nodes, and the third task nodes.

Referring again to FIG. 3, at operation 325, a checklist is marked as an issue list. In an embodiment, an issue list monitors an unplanned aspect of the project. In such embodiments, all items on the issue list are treated as issues.

In an embodiment, one or more of the first project summary task node, the second summary task nodes, and the third task nodes are assigned to a checklist via a checklist item. Upon the creation of a checklist item, the process may be configured so that the checklist item is automatically associated with one or more of the first project summary task node, the second summary task nodes, and the third task nodes that the checklist is assigned to.

FIG. 5 is an overview diagram of a hardware and operating environment in conjunction with which embodiments of the invention may be practiced. The description of FIG. 5 is intended to provide a brief, general description of suitable computer hardware and a suitable computing environment in conjunction with which the invention may be implemented. In some embodiments, the invention is described in the general context of computer-executable instructions, such as program modules, being executed by a computer, such as a personal computer. Generally, program modules include routines, programs, objects, components, data structures, etc., that perform particular tasks or implement particular abstract data types.

Moreover, those skilled in the art will appreciate that the invention may be practiced with other computer system configurations, including hand-held devices, multiprocessor systems, microprocessor-based or programmable consumer electronics, network PCS, minicomputers, mainframe computers, and the like. The invention may also be practiced in distributed computer environments where tasks are performed by I/0 remote processing devices that are linked through a communications network. In a distributed computing environment, program modules may be located in both local and remote memory storage devices.

In the embodiment shown in FIG. 5, a hardware and operating environment is provided that is applicable to any of the servers and/or remote clients shown in the other Figures.

As shown in FIG. 5, one embodiment of the hardware and operating environment includes a general purpose computing device in the form of a computer 20 (e.g., a personal computer, workstation, or server), including one or more processing units 21, a system memory 22, and a system bus 23 that operatively couples various system components including the system memory 22 to the processing unit 21. There may be only one or there may be more than one processing unit 21, such that the processor of computer 20 comprises a single central-processing unit (CPU), or a plurality of processing units, commonly referred to as a multiprocessor or parallel-processor environment. In various embodiments, computer 20 is a conventional computer, a distributed computer, or any other type of computer.

The system bus 23 can be any of several types of bus structures including a memory bus or memory controller, a peripheral bus, and a local bus using any of a variety of bus architectures. The system memory can also be referred to as simply the memory, and, in some embodiments, includes read-only memory (ROM) 24 and random-access memory (RAM) 25. A basic input/output system (BIOS) program 26, containing the basic routines that help to transfer information between elements within the computer 20, such as during start-up, may be stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media.

The hard disk drive 27, magnetic disk drive 28, and optical disk drive 30 couple with a hard disk drive interface 32, a magnetic disk drive interface 33, and an optical disk drive interface 34, respectively. The drives and their associated computer-readable media provide non volatile storage of computer-readable instructions, data structures, program modules and other data for the computer 20. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), redundant arrays of independent disks (e.g., RAID storage devices) and the like, can be used in the exemplary operating environment.

A plurality of program modules can be stored on the hard disk, magnetic disk 29, optical disk 31, ROM 24, or RAM 25, including an operating system 35, one or more application programs 36, other program modules 37, and program data 38. A plug in containing a security transmission engine for the present invention can be resident on any one or number of these computer-readable media.

A user may enter commands and information into computer 20 through input devices such as a keyboard 40 and pointing device 42. Other input devices (not shown) can include a microphone, joystick, game pad, satellite dish, scanner, or the like. These other input devices are often connected to the processing unit 21 through a serial port interface 46 that is coupled to the system bus 23, but can be connected by other interfaces, such as a parallel port, game port, or a universal serial bus (USB). A monitor 47 or other type of display device can also be connected to the system bus 23 via an interface, such as a video adapter 48. The monitor 40 can display a graphical user interface for the user. In addition to the monitor 40, computers typically include other peripheral output devices (not shown), such as speakers and printers.

The computer 20 may operate in a networked environment using logical connections to one or more remote computers or servers, such as remote computer 49. These logical connections are achieved by a communication device coupled to or a part of the computer 20; the invention is not limited to a particular type of communications device. The remote computer 49 can be another computer, a server, a router, a network PC, a client, a peer device or other common network node, and typically includes many or all of the elements described above I/0 relative to the computer 20, although only a memory storage device 50 has been illustrated. The logical connections depicted in FIG. 5 include a local area network (LAN) 51 and/or a wide area network (WAN) 52. Such networking environments are commonplace in office networks, enterprise-wide computer networks, intranets and the internet, which are all types of networks.

When used in a LAN-networking environment, the computer 20 is connected to the LAN 51 through a network interface or adapter 53, which is one type of communications device. In some embodiments, when used in a WAN-networking environment, the computer 20 typically includes a modem 54 (another type of communications device) or any other type of communications device, e.g., a wireless transceiver, for establishing communications over the wide-area network 52, such as the internet. The modem 54, which may be internal or external, is connected to the system bus 23 via the serial port interface 46. In a networked environment, program modules depicted relative to the computer 20 can be stored in the remote memory storage device 50 of remote computer, or server 49. It is appreciated that the network connections shown are exemplary and other means of, and communications devices for, establishing a communications link between the computers may be used including hybrid fiber-coax connections, T1-T3 lines, DSL's, OC-3 and/or OC-12, TCP/IP, microwave, wireless application protocol, and any other electronic media through any suitable switches, routers, outlets and power lines, as the same are known and understood by one of ordinary skill in the art.

The Abstract is provided to comply with 37 C.F.R. §1.72(b) to allow the reader to quickly ascertain the nature and gist of the technical disclosure. The Abstract is submitted with the understanding that it will not be used to interpret or limit the scope or meaning of the claims.

1. A process for managing a project comprising:
providing a first project summary task node;
providing one or more second summary task nodes associated with the first project summary task node;
providing one or more third task nodes for each second summary task node; and
providing a checklist including one or more checklist items, and further providing one or more tasks for each checklist item;
wherein the one or more tasks for a checklist item are associated with one or more of the first project summary task node, the second summary task nodes, and the third task nodes.

2. The process of claim 1, wherein the checklist is configured to monitor a predefined aspect of the project.

3. The process of claim 1, further comprising marking a checklist as an issue list, wherein the issue list is to monitor an unplanned aspect of the project, and further wherein all items on the issue list are treated as issues.

4. The process of claim 1, wherein one or more of the first project summary task node, the second summary task nodes, and the third task nodes are associated with a plurality of checklists.

5. The process of claim 1, further comprising configuring the process so that when a new checklist item is created, an associated new task is created.

6. The process of claim 5, further comprising configuring the process so that when the new checklist item is created, the checklist item and the associated new task are linked to an existing one or more of the first project summary task node, the second summary task nodes, and the third task nodes.

7. The process of claim 1, further comprising configuring the process so that one or more of the first project summary task node, the second summary task nodes, and the third task nodes are assigned to a checklist via a checklist item.

8. The process of claim 1, further comprising configuring the process to allow the creation of a checklist item, and further configuring the process so that the checklist item is automatically associated with one or more of the first project summary task node, the second summary task nodes, and the third task nodes that the checklist is assigned to.

9. A project management system comprising:
a module to provide a first project summary task node;
a module to provide one or more second summary task nodes associated with the first project summary task node;
a module to provide one or more third task nodes for each second summary task node; and
a module to provide a checklist including one or more checklist items, and further providing one or more tasks for each checklist item;
wherein the one or more tasks for a checklist item are associated with one or more of the first project summary task node, the second summary task nodes, and the third task nodes.

10. The project management system of claim 9, wherein the checklist is configured to monitor a predefined aspect of the project.

11. The project management system of claim 9, further comprising a module to mark a checklist as an issue list, wherein the issue list is to monitor an unplanned aspect of the project, and further wherein all items on the issue list are treated as issues.

12. The project management system of claim 9, wherein one or more of the first project summary task node, the second summary task nodes, and the third task nodes are associated with a plurality of checklists.

12. The project management system of claim 9, further comprising:
a module to configure the process so that when a new checklist item is created, an associated new task is created; and
a module to configure the process so that when the new checklist item is created, the checklist item and the associated new task are linked to an existing one or more of the first project summary task node, the second summary task nodes, and the third task nodes.

13. The project management system of claim 9, further comprising a module to configure the process so that one or more of the first project summary task node, the second summary task nodes, and the third task nodes are assigned to a checklist via a checklist item.

14. The project management system of claim 9, further comprising a module to configure the process to allow the creation of a checklist item, and further comprising a module to configure the process so that the checklist item is automatically associated with one or more of the first project summary task node, the second summary task nodes, and the third task nodes that the checklist is assigned to.

15. A machine-readable medium comprising instructions thereon for executing a process for managing a project comprising:
providing a first project summary task node;
providing one or more second summary task nodes associated with the first project summary task node;
providing one or more third task nodes for each second summary task node; and
providing a checklist including one or more checklist items, and further providing one or more tasks for each checklist item;
wherein the one or more tasks for a checklist item are associated with one or more of the first project summary task node, the second summary task nodes, and the third task nodes.

16. The machine-readable medium of claim 15, wherein the checklist is configured to monitor a predefined aspect of the project.

17. The machine-readable medium of claim 15, further comprising instructions for marking a checklist as an issue list, wherein the issue list is to monitor an unplanned aspect of the project, and further wherein all items on the issue list are treated as issues.

18. The machine-readable medium of claim 15, wherein one or more of the first project summary task node, the second summary task nodes, and the third task nodes are associated with a plurality of checklists.

19. The machine-readable medium of claim 15, further comprising instructions for:
configuring the process so that when a new checklist item is created, an associated new task is created; and
configuring the process so that when the new checklist item is created, the checklist item and the associated new task are linked to an existing one or more of the first project summary task node, the second summary task nodes, and the third task nodes.

20. The machine-readable medium of claim 15, further comprising instructions for:
configuring the process so that one or more of the first project summary task node, the second summary task nodes, and the third task nodes are assigned to a checklist via a checklist item; and
configuring the process to allow the creation of a checklist item, and further configuring the process so that the checklist item is automatically associated with one or more of the first project summary task node, the second summary task nodes, and the third task nodes that the checklist is assigned to.
